(19) United States
(12) Patent Application Publication
(10) Pub. No.: US 2026/0120337 A1
(43) Pub. Date: Apr. 30, 2026

(54) GENERATIVE MODEL PROMPT AUGMENTATION

(71) Applicant: Lenovo Global Technology (United States) Inc., Morrisville, NC (US)

(72) Inventors: Kevin W Beck, Morrisville, NC (US); Song Wang, Morrisville, NC (US); Mengnan Wang, Morrisville, NC (US); Robert James Norton, JR., Morrisville, NC (US)

(21) Appl. No.: 18/932,600

(22) Filed: Oct. 30, 2024

(51) Int. Cl. G06T 11/00

(52) U.S. Cl. CPC G06T 11/00

(57) ABSTRACT

In one aspect, a device may include a processor system and storage accessible to the processor system. The storage may include instructions executable by the processor system to receive a prompt to a model, and to augment the prompt with data related to one or more user preferences. The instructions may then be executable to provide the augmented prompt as input to the model, and to receive an output from the model that indicates a generative image or generative text in conformance with the augmented prompt. Thus, in some examples the model may include a generative image model, and the output may include a generative image. Also in some examples, the model may include a large language model or other generative text model, and the output may include generative text.

### FIELD

The disclosure below relates to technically inventive, non-routine solutions that are necessarily rooted in computer technology and that produce concrete technical improvements. In particular, the disclosure below relates to generative model prompt augmentation.

### BACKGROUND

As recognized herein, generative artificial intelligence (AI) models can produce generative text and images based on prompts provided to them as input. However, this disclosure also recognizes that given the vast amounts of data a generative model is trained on, the resulting generative output is often times not in line with what the user had in mind. No adequate solutions currently exist to the foregoing computer-related, technological problem.

### SUMMARY

Accordingly, in one aspect a device includes a processor system and storage accessible to the processor system. The storage includes instructions executable by the processor system to receive a prompt to a generative image model, and to augment the prompt with data related to one or more user preferences indicated via user input. The instructions are also executable to provide the augmented prompt as input to the generative image model. Based on providing the augmented prompt as input to the generative image model, the instructions are then executable to receive an output from the generative image model, with the output indicating a generative image in conformance with the augmented prompt.

In some examples, the instructions may be executable to augment the prompt by using the data to alter the prompt to indicate the one or more user preferences. Additionally or alternatively, the instructions may be executable to augment the prompt by appending the data to the prompt as an addition to the prompt.

Additionally, in one example implementation the instructions may be executable to identify the one or more user preferences based on audible, verbal input from a user as received prior to receipt of the prompt. The audible, verbal input may relate to an object in a geographic area. If desired, the instructions may even be executable to identify the one or more user preferences by accessing data related to the geographic area to identify the object and then correlating the audible, verbal input related to the object to the one or more user preferences based on the geographic area data. The geographic area data may include each of a feature map of the geographic area, a structure mesh of the geographic area, texture data for the geographic area, and a semantic model of the geographic area. What’s more, in some non-limiting instances the generative image model may be a first model, and here the instructions may then be executable to train a second model, based on the one or more user preferences, to output the data related to the one or more user preferences, with the second model being different from the first (generative image) model. The second model may include a large language model, for example.

Also in example embodiments, the instructions may be executable to identify the one or more user preferences based on a user’s Internet browser history and/or based on the user’s social media data.

In another aspect, a method includes receiving a prompt to a generative image model and augmenting the prompt with data related to one or more user preferences indicated via user input. The method then includes using the generative image model to, based on the augmented prompt, receive an output indicating a generative image in conformance with the augmented prompt.

In some examples, the method may include providing the augmented prompt as input to the generative image model to use the generative image model to receive the output.

Still further, in some examples the method may also include training the generative image model to augment received prompts with user preferences to produce generative outputs that incorporate the one or more user preferences.

In various example implementations, the method may further include identifying the one or more user preferences based on user input as received prior to receipt of the prompt. The user input may relate to an aspect of a geographic area. Additionally, in certain non-limiting instances, the method may include identifying the one or more user preferences by accessing texture data for the geographic area and a semantic model of the geographic area, and then correlating the user input to the one or more user preferences based on the texture data and the semantic model.

In still another aspect, at least one computer readable storage medium (CRSM) that is not a transitory signal includes instructions executable by a processor system to receive a prompt to a model. The instructions are also executable to augment the prompt with data related to one or more user preferences indicated via user input. The instructions are further executable to use the model to, based on the augmented prompt, receive a generative output in conformance with the augmented prompt.

In some example implementations, the model may include a generative image model, and the output may include a generative image. Additionally or alternatively, the model may include a large language model, and the output may include generative text.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows a user touring a personal residence and verbally indicating a particular user preference which is then used to augment a prompt to a generative model consistent with present principles;

FIG. 4 shows an example graphical user interface (GUI) into which an initial, user-specified prompt may be entered consistent with present principles;

FIG. 5 shows an example generative image as generated by a model based on an augmented prompt consistent with present principles;

FIG. 6 illustrates example logic in example flow chart format that may be executed by a device consistent with present principles;

FIG. 7 shows example artificial intelligence (AI) architecture that may be used consistent with present principles; and

FIG. 8 shows an example settings GUI consistent with present principles.

### DETAILED DESCRIPTION

Among other things, the detailed description below discusses devices and methods for creating visual generative AI prompts from analysis of augmented reality (AR) data and subjective preference ratings. Specific qualities of a desired generative object/item may be quantified and described for inclusion in the generative output. Additionally, the degree to which environmental factors such as location, size, color, and lighting are evident for those items may also be quantified and described, and/or the specific combinations of those factors quantified and described, for use to produce generative outputs in conformance with the user’s subjective preferences as indicated via user input.

Also in some non-limiting instances, an integrated AR space map may be used. The AR space map may include a feature map which provides spatial localization functions and location information for mobile devices (e.g., as might also be used for navigation). The AR space map may also include a structure mesh (or structure map) which might also be used by developers to support virtual-real fusion editing and path planning, with overlaid AR contents possibly being presented on top of physical objects. Texture data (or a texture map) may also be included, which may provide high-fidelity visualization of a three-dimensional (3D) scene to help create an interactive user experience, with the texture data including appearance qualities such as color, lighting, physical texture, etc. The AR space map may further include a semantic model (or a semantic map) that provides detection and recognition capabilities for objects inside the 3D scene, such as object recognition from big data and/or user labelling.

A device operating consistent with present principles may therefore use the data from those four maps/data sources (e.g., from preexisting AR content, or as generated by the user in their own private space or on tour of a public space or gallery, etc.), combined with a user’s input regarding their preferences/tastes/subjective judgements about items in the environment.

This preference/taste input about the user’s likes/dislikes of a particular item (e.g., work of art, furniture, room layout, color scheme, item size, etc. or any combination of those and other factors) may then be corelated and analyzed over n>1 instances of input to build a model of the user’s preferences/taste. The model may thus quantify and describe the effects of the location, size/shape, appearance, and combination of those factors, on the user’s subjective preferences about certain objects/items.

The model may then be used during deployment to build a comprehensive set of prompts for a visual generative AI (or other type of generative AI), which allows the AI model to generate visuals which accurately represent the user’s desired image.

As a first example, suppose a user tours multiple open houses while searching for a new house to buy, but doesn’t know exactly what they are looking for in a kitchen, living room, etc. During the course of multiple tours, the user is wearing an AR device like smart glasses which records and collects visual and semantic data about the houses, building the maps/texture data mentioned above. During the course of these multiple tours, the device also solicits/collects the user’s subjective feedback about the location, size, color, and surface materials/finish of all of the appliances, cabinets, flooring, furniture, light fixtures, etc. in the viewed houses. This aggregate data may then be correlated and analyzed to produce a model which determines that the user likes a “modern” style with light wood floors, no carpet, large warm-toned rugs, indirect lighting, stainless steel appliances, smaller tables, etc.

Thus, according to this example, text synthesis from speech recognition may be sent to the AI generative model to attach virtual objects on the go as the user traverses through a given open house. For example, the user can preemptively say, “I like a 65-inch TV on top of the fireplace, a three-seat sofa in the middle of the room , etc.” This model is then used to build a comprehensive set of prompts for a visual generative AI model, which is then used by the AI model to generate a reference visual that represents their “taste.” The model may even be used as a reference for realtors, interior designers, etc. Thus, virtual objects of a 65-inch TV and fireplace may later be integrated into a preferred, virtual house floor plan the user might desire and provided to the user’s real estate agency for reference by the agency to gain a fuller understanding of the user’s tastes.

As a second example, suppose a user wants a generative AI model to generate images of a landscape layout for use by the user’s landscape architect, designer, installer, landscaping service, etc. During the course of multiple visits to city gardens, arboretums, garden/plant centers, and neighborhood tours, the user is wearing an AR device which records and collects visual and semantic data about the gardens, plants etc. to build the four maps/texture data mentioned above. During the course of these multiple visits, the device also solicits/collects the user’s subjective feedback about the location, size, color, variety, spacing, layout, etc. of the plants in the locations the user visits. This aggregate data is then correlated and analyzed to produce a model which embeds that the user likes an open landscape layout, with primarily low growing evergreens, some small trees, regularly spaced bright flowers, etc. This model is then used to build a comprehensive set of prompts for a visual generative AI model, with those prompts then being used by the AI model to generate a reference visual representing the user’s tastes (which can then also be used as a reference for the landscape architect, designer, installers, etc. to provide services according to the user’s tastes).

Present principles may therefore be used in AR and VR embodiments (more generally, mixed reality (MR) embodiments), but are not so limited. Present principles may be implemented as a seamless front-end to a generative AI model, and/or as a stand-alone prompt augmenter such as a large language model (LLM) trained on the user’s preferences. Rules-based algorithms may also be used.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java^{®}/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

"A system having at least one of A, B, and C" (likewise "a system having at least one of A, B, or C" and "a system having at least one of A, B, C") includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

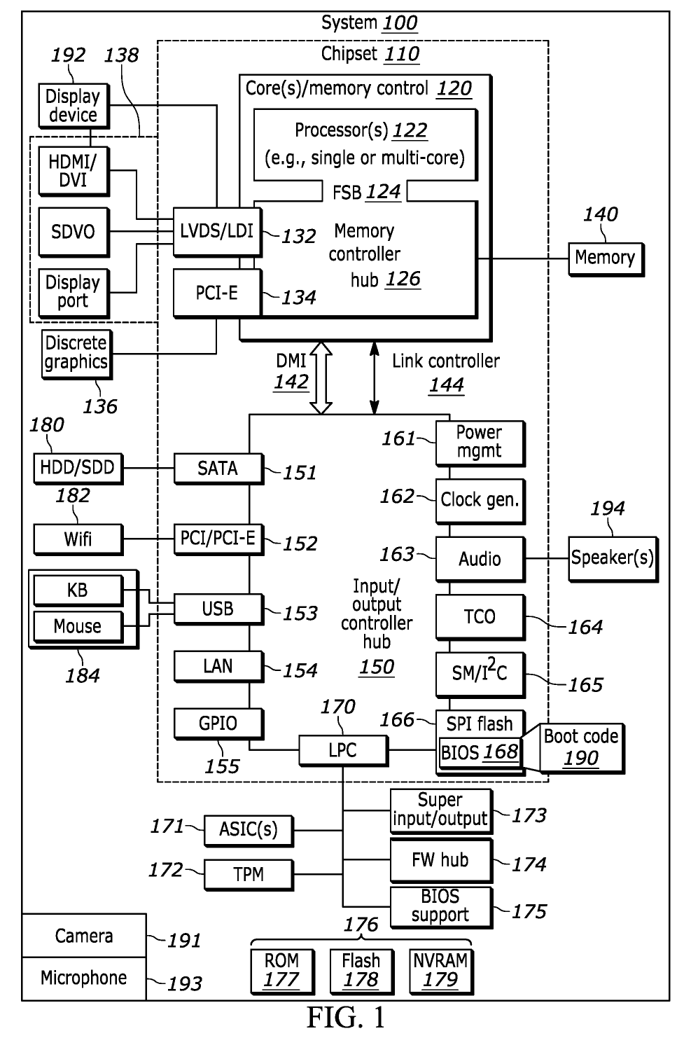

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include a camera 191 that gathers one or more images and provides the images and related input (e.g., metadata like an image timestamp) to the processor system 122. The camera 191 may be a thermal imaging camera, an infrared (IR) camera, a digital camera such as a webcam, a three-dimensional (3D) camera, and/or a camera otherwise integrated into the system 100 and controllable by the processor system 122 to gather still images and/or video (e.g., from which user preference data may be determined consistent with present principles). The system 100 may also include an audio receiver/microphone 193 that provides input from the microphone to the processor system 122 based on audio that is detected, such as via a user providing audible input to the microphone (e.g., also from which user preference data may be determined consistent with present principles).

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

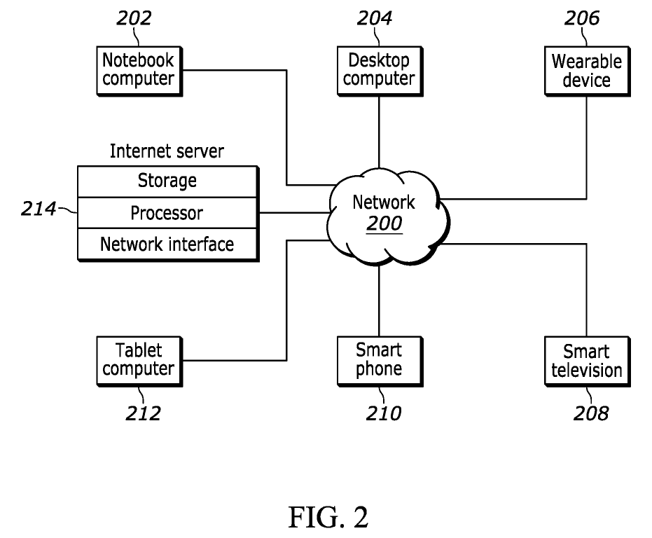

Turning now to FIG. 2, example devices are shown communicating over a network 200 such as the Internet to undertake present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles. For example, a prompt to a generative image model may be received at a client device such as the computer 202 or smartphone 210, and then the prompt may be transmitted to the server 214 for execution of the model at the server to produce a generative output in conformance with the prompt (the generative image model being hosted and executed at the server according to this example).

With this in mind, note that present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTs) also may be used. Support vector machines (SVM) and Bayesian networks also may also be considered as examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

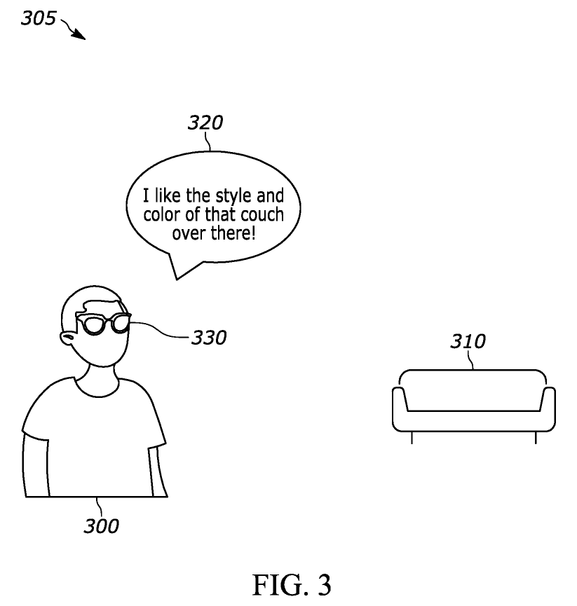

Now in reference to FIG. 3, suppose an end-user 300 is touring houses that the user 300 might wish to buy or take a possessory interest in during a search for a personal residence. As such, the user 300 might be visiting a particular geographic area such as a single-family home 305.

Also suppose that while at the home 305, the user 300 sees a couch 310 that the user 300 likes according to the user’s own personal preferences. Upon seeing the couch 310, the user 300 might say something like, “I like the style and color of that couch over there!” as illustrated by speech bubble 320. Smart glasses 330 worn by the user may then pick up on that audible input via the glasses’ on-device microphone (e.g., using speech recognition) to then execute further processing in response. Additionally or alternatively, a mobile phone carried by the user may identify the audible input. The additional processing may include identifying various characteristics of the couch 310 not just in isolation but in the context of other aspects of the home 305. The characteristics of the couch 310 may then be saved as positive user preference data associated with the user 300.

As one particular example, suppose the glasses 330 have already been monitoring the user’s environment(s) via real-time computer vision (using one or more on-device cameras that face outward away from the glasses 330). Red green blue (RGB) images/video and infrared (IR) images/video of the home 305 may therefore be processed using computer vision and a convolutional neural network (CNN) to build a feature map of the area. In some specific instances, simultaneous localization and mapping (SLAM) may additionally or alternatively be executed to generate the feature map using the camera images/video.

The RGB and IR images/video from the camera(s) may also be used to generate texture data about various aspects of the home 305, including texture data for particular objects like the couch 310, walls, tables, etc. The texture data itself may include colors of the respective objects, three-dimensional (3D) surface texture(s) of the objects, lighting reflecting off the respective objects, visual patterns of the objects, and other surface details about aspects of the home 305.

What’s more, RGB and IR images/video may be used to generate a semantic model of the home 305 through object recognition, with object identifiers (IDs) being assigned to various objects represented in the model as recognized from the geographic area.

The glasses 330 may also have a light detection and ranging (Lidar) transceiver. The glasses 300 can therefore use the Lidar transceiver to determine ranges to and between different objects of the home 305. That data can then be used to build a structure mesh or map of the geographic area. Other types of transceivers may also be used to do so, such as a radar transceivers and ultrasonic rangefinders.

Note that according to the above the glasses 330 themselves may generate the feature map, structure mesh, texture data, and/or semantic model. However, also note that, in some embodiments, the glasses 330 may do so in coordination with a remotely-located server which performs some or all of the sensor processing and map building.

Either way, having preemptively generated the feature map of the geographic area, the structure mesh of the geographic area, the texture data for the geographic area, and the semantic model of the geographic area when the glasses 330 entered the area and the user 300 subsequently traversed the area, the glasses 330 and/or server may then determine various characteristics of the couch 310 as well as the surrounding environment in response to the user’s audible, verbal input related to the couch 310 to thus infer one or more positive user preferences related to the couch 310. The inferred positive user preferences may also relate to furniture more generally and even home layouts more generally. But assume for the present example that the user preferences relate to furniture style, size, and color for the couch 310. The preferences related to the couch 310 may also include furniture spacing of the couch 310 in real space relative to other objects in the space, and the couch’s location within a room of a given room type (e.g., by a window in a living room or bedroom).

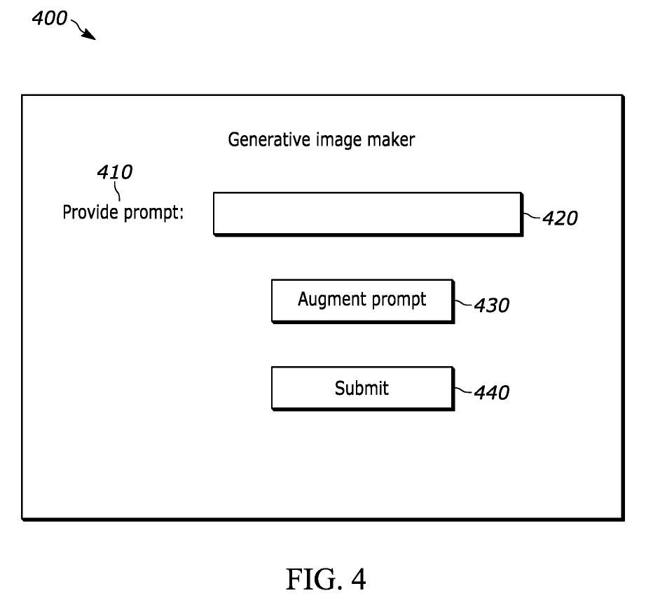

The determined user preferences may then be used by the glasses 330 and/or connected device to assist in the production of generative images by a generative image model. To further illustrate, refer to FIG. 4.

As shown in this figure, a graphical user interface (GUI) 400 may be presented on a display of the user’s client device, such as the transparent display of the glasses 330, the display of the user’s smartphone, etc. The GUI 400 may be used to enter a prompt to a generative image model for the model to then generate an image in conformance with the user’s preferences. Accordingly, instructions 410 may instruct the user to enter a prompt into the text entry box 420 using a hard or soft keyboard. In some examples, the user may then select the submit selector 440 to command the system to provide the prompt as entered into box 420, along with the user’s preference data, as input to the generative image model for the model to then generate a fictional image in response.

However, also note that in some examples the system may give the user a choice between generating an image based on their initial prompt alone (as entered into the box 420), and generating an image based on the prompt plus user preference data. For the former option, the user may simply enter the prompt into the box 420 and then select the selector 440. For the latter option, the user can augment the specific (initial) prompt provided by the user with the user’s preference data by selecting the “augment prompt” selector 430 to command the device to then generate an image based on the prompt and preference data.

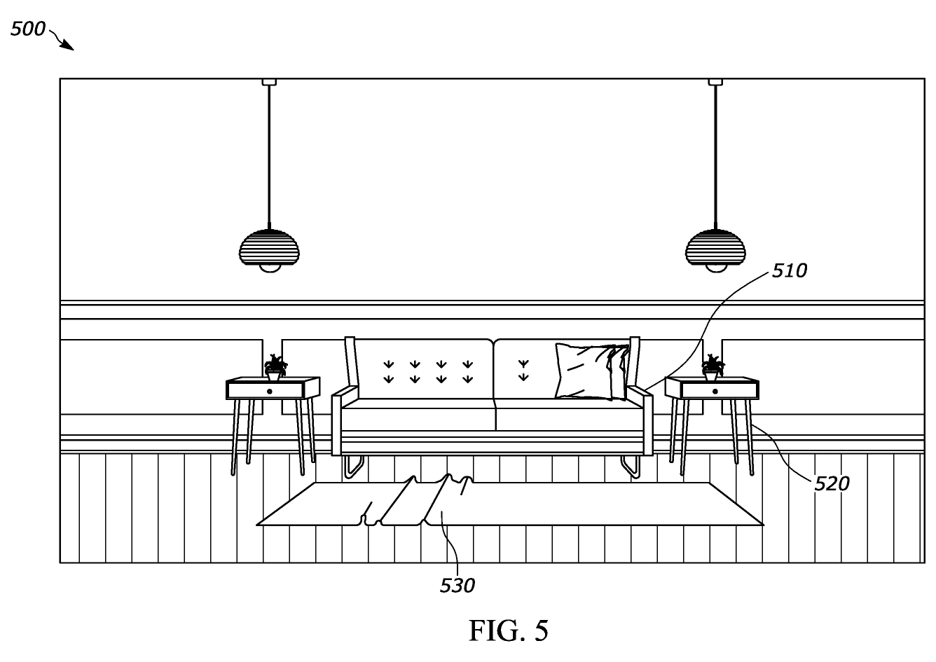

FIG. 5 then shows an example generative RGB image 500 as indicated in the output from the generative image model and presented on the display of the user’s client device. As shown in this figure, the image 500 includes a couch 510 in the same furniture style and color already identified as being preferred by the user. The image 500 may also include other generative objects along with the couch 510, including end tables 520 and a rug 530 as shown.

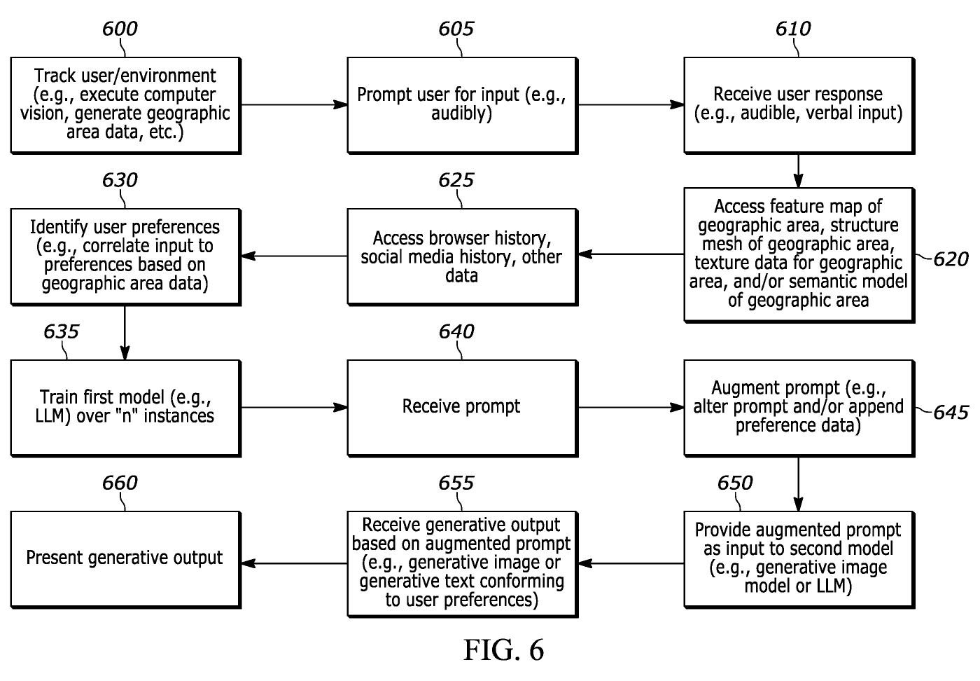

Continuing the detailed description in reference to FIG. 6, this figure shows example logic that may be executed by a device such as the system 100 and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 6 is shown in flow chart format, other suitable logic may also be used.

Beginning at block 600, the device may track a user and environment as the user moves about the environment. For example, the device may track the user through camera input to identify positive and negative facial expressions of the user using emotion recognition. The device may also track the user’s environment as set forth above, such as by using computer vision and lidar to generate geographic area data for the environment. Again note that the geographic area data may include a feature map of the geographic area, a structure mesh of the geographic area, texture data for the geographic area, and/or a semantic model of the geographic area.

From block 600 the logic may then proceed to block 605. At block 605 the device may prompt the user for the user’s preferences about one or more aspects of the environment. For instance, rather than passively monitoring for unsolicited user input according to the example of FIG. 3, in some examples the device may audibly or visually prompt the user for user input to indicate the user’s preference for a given object in the user’s field of view. Therefore, in one particular instance, the device might present an audible prompt through speakers on the glasses 330 that asks, “What do you think of that couch?”

Then at block 610 the device may receive an audible user response to the prompt and/or otherwise receive unsolicited user input indicating the user’s preference(s) in relation to the couch. For example, the user might say “I like the couch” or “I like its style and the layout of this living room.” The user’s audible input may then be processed using speech-to-text software, emotion recognition, and natural language processing, for example.

As another example, note that the prompt presented at block 605 (“What do you think of that couch?”) may be presented as text on a graphical user interface (GUI). That GUI may also include a “thumbs up” selector and a “thumbs down” selector for the user to then provide positive or negative feedback on the particular object (couch) indicated via the GUI. The GUI may also include a text entry box where the user can enter freeform text, such as the text “I like that couch.” The device may then generate respective positive or negative user preference data based on selection of the thumbs up or thumbs down selector and/or the freeform text.

From block 610 the logic may then proceed to block 620 where the device may access the feature map, structure mesh, texture data, and/or semantic model of the associated geographic area itself. Thus, note that in some examples the device may access those items as already generated at block 600 and saved to persistent storage accessible to the device. Additionally or alternatively, the device may access those items as previously generated and saved by another client device.

After block 620 the logic may then proceed to block 625. At block 625 the device may access other digital data associated with the user that indicates preferences of the user. Examples of digital preference data therefore include, but are not limited to, the user’s Internet browser history, the user’s social media history (including likes and dislikes of content/posts of others on the social media platform as well as the user’s own profile data as specified by the user themselves), emails in the user’s email account, short messaging service (SMS)-based cellular text messages, multimedia messaging service (MMS)-based cellular text messages, and still other sources.

From block 625 the logic may then proceed to block 630 where one or more of the user’s preferences may actually be identified if the device has not already done so. For example, the user’s preferences may be identified at block 630 based on the audible, verbal input from the user as received prior to receipt of the prompt presented to the user at block 605. Again note that the audible, verbal input might relate to an object in a geographic area or to another aspect of the geographic area (e.g., style of home or furniture, furniture layout of a room, positioning of objects within a room, etc.). So here, the device may access each of the feature map of the geographic area, the structure mesh of the geographic area, the texture data for the geographic area, and/or the semantic model of the geographic area to identify the object at block 620 to then, at block 630, correlate the audible, verbal input to one or more user preferences based on the feature map, the structure mesh, the texture data, and the semantic model.

Or as another non-limiting example, the device might only access the texture data for the geographic area and the semantic model of the geographic area to then correlate the user input to the one or more user preferences at block 630 based on the texture data and the semantic model. This may be done based on the recognition that those two things at minimum may be used to affirmatively identify useful preference data in relation to objects in the user’s environment according to the user’s audible input (e.g., at least object type for a particular object referenced by the user per the semantic model, and associated object color per the texture data). However, present principles further recognize that to further improve device functionality in terms of identification of user preferences for deep learning, one or both of the feature map and the structure mesh may also be used (e.g., feature map for identifying preferred object location relative to other objects within the environment, and structure mesh for identifying object size and/or preferred depth of the object relative to other objects).

User preferences may also be identified at block 630 from the aforementioned Internet browser history, social media data, emails, SMS-based text messages, etc. The text and images from those sources may be processed using multimodal sentiment analysis and other emotion recognition techniques to identify the user’s preferences, with those preferences sometimes being classified as positive sentiments about an associated element and sometimes being classified as negative sentiments about the associated element depending on the underlying digital data itself.

Positive and negative preferences, whether identified through the user’s audible input or other methods discussed above, may then be used at block 635 to train an artificial intelligence (AI) model to output prompts to still other generative models, with those prompts being related to the one or more user preferences themselves. Reinforcement learning may therefore be used, as well as supervised learning, unsupervised learning, and still other deep learning techniques. The AI model itself that is trained on the user’s preferences may be one configured for pattern recognition and, as such, may include one or more convolutional neural networks and/or one or more recurrent neural networks (more generally, one or more deep artificial neural networks). Identified patterns in user preferences may then be used for that model to output one or more text words articulating or describing the associated user preference for a given element provided as input (e.g., “couch” or “chair” being input). In one specific example instance, the model that is trained at block 635 may include a generative pre-trained transformer (GPT) or other large language model (LLM) that is specifically trained to output text prompts for other generative AI models to then use.

However, also in one example instance, the model that is trained at block 635 may be or include the same generative model to which the user-based prompt that is augmented by the device is ultimately provided for subsequent generation of a generative image (or other generative output) according to the user’s preferences. Thus, the prompt’s augment data may be generated by an earlier layer of the same generative model for the augment data to then be provided with the user’s initial prompt to later layers of the same model for that model to then generate a generative image according to the prompts and augment data.

Either way, after training the model to augment received prompts with user preferences for the device to ultimately produce generative outputs that incorporate the one or more user preferences, the logic may proceed to block 640 to receive an initial prompt from a user to a generative image model in a first instance. The logic may then proceed to block 645 where the device may augment the initial prompt received in the first instance with data from the trained model that is related to one or more of the user’s preferences as apposite to an object of the initial prompt itself. In some non-limiting instances, augmenting the initial prompt may include using the data to alter the text string of the initial prompt itself to indicate the one or more user preferences, possibly while also deleting other aspects of the initial prompt as provided by the user. Additionally or alternatively, augmenting the prompt may include appending the augment data to the text string of the initial prompt as an addition to the text string of the initial prompt, whether or not also augmenting the prompt by changing aspects of the text string of the initial prompt itself.

From block 645 the logic may then proceed to block 650. At block 650 the device may provide the augmented prompt as input to the generative image model. Then at block 655, based on providing the augmented prompt as input to the generative image model, the device may receive an output from the generative image model that indicates a generative image in conformance with the augmented prompt. The logic may then proceed to block 660 where the device may present the generative image on the display of the user’s client device.

So as an example, if the user provided the text string “couch” and the model trained on the user’s preferences then augments the initial prompt as “blue couch, sectional style,” the latter may be provided to the generative image model as input. The generative image model may then be executed to provide a generative image showing a sectional couch in the user’s favorite color (blue).

Notwithstanding the foregoing, it is to be further understood consistent with present principles that in some instances the user might be providing the initial prompt to a large language model or other text-generating model rather than to a generative image model (for instances where the user ultimately wants generative text instead of a generative image). In such instances, the device may provide the augmented prompt as input to the large language model at block 650 to then, at block 655, receive an output from the large language model model that indicates generative text in conformance with the augmented prompt. From there the device may present the generative text on the display of the user’s client device at block 660.

So as an example, if the user provided the text string “write an email to my colleague” and the trained model then augments the initial prompt as “write an email to my colleague in a very cordial style while using oxford commas,” the latter may be provided to the generative text model as input. The generative text model may then be executed to provide generative text that includes a text string that addresses the colleague in a cordial manner and that also uses oxford commas for conjunctions in any enumeration of three or more items in the text itself.

What’s more, for completeness and as alluded to above, regardless of whether the user is prompting a generative image model or a generative text model (“first model”) for an associated generative image/text output, the model trained at block 635 (“second model”) may be the same as or different from the first model. So in one instance, the first model may be the same as the second model, with the first model itself being trained based on the user’s preferences to output conforming text/image outputs. In other instances, the first model may be different from the second model, with the second model being a large language model or other text generator that has been trained based on the user’s preferences to augment initial prompts for the first model to then use the augmented prompt as input to provide conforming text/image outputs in response.

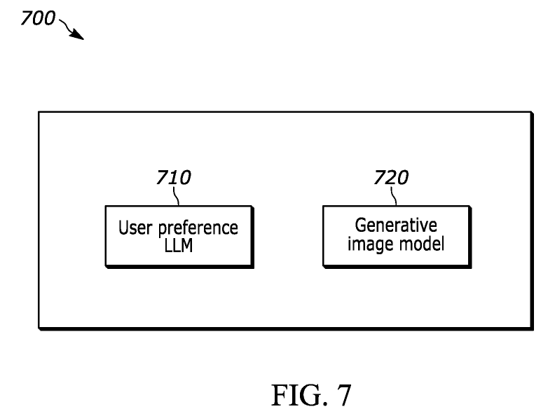

An example of AI architecture for the latter of those two situations is shown in FIG. 7. Accordingly, in reference to FIG. 7, this figure shows example AI architecture 700 that may be implemented consistent with present principles. The architecture 700 includes a (discriminative) pattern recognizer model 710 which may be established by one or more convolutional neural networks, one or more recurrent neural networks, and/or one or more GPTs. In one particular example, the model 710 may be a user preference-trained LLM configured to output augmented prompts as generative text according to user preferences that have been embedded in vector space.

FIG. 7 also shows that the architecture 700 may include a generative image model 720 that may be a (generative) AI model configured outputting generative images based on augmented prompts from the LLM 710. In various non-limiting examples, the model 720 may be a text-to-image model such as an image diffusion model (e.g., latent diffusion model like Stable Diffusion). An encoder-decoder model and a transformer model in combination may also be used, as may a generative adversarial network (GAN) such as a Deep Convolutional Generative Adversarial Network (DCGAN). Still other generative image models may be used.

Accordingly, during deployment, an initial prompt from a user may be provided as input to the first model 710. The first model 710 may then be executed to output text (augmented prompt) that is then fed into the second model 720 as input. The second model 720 may then be executed to generate an image based on the input (augmented prompt).

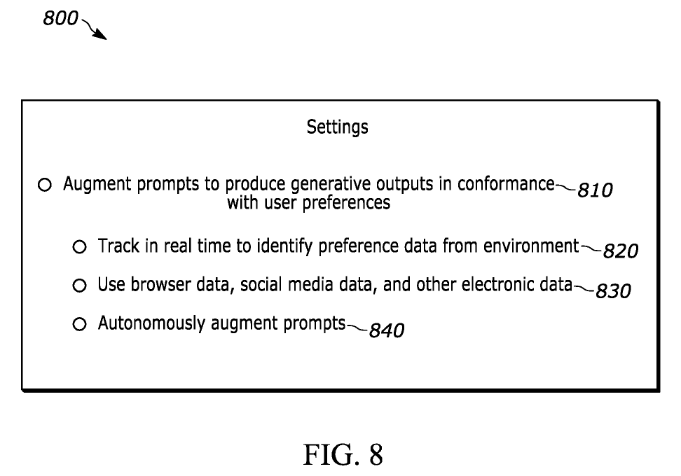

Continuing the detailed description in reference to FIG. 8, this figure shows an example GUI 800 that may be presented on a client device display for an end-user to configure one or more settings of a device or software application (“app”) to operate consistent with present principles. Each option discussed below may be selected by selecting the respective check box shown adjacent to that option, whether through cursor input, touch input, or another type of input.

As shown, the GUI 800 may include a first option 810 that is selectable a single time to set or enable the device to, for multiple future instances of generative output production, augment initial prompts specified by users to help produce generative outputs in conformance with user preferences. Therefore, the option 810 may be selected to set or configure the device to undertake the functions described above with respect to FIGS. 3-7.

The GUI 810 may also include other options into which the user may opt-in. Those options include an option 820 to set or enable the device to track the user and user’s environment in real time to identify user preference data from the user and environment as the user moves about. The option 830 may be selected to set or enable the device to use browser data, social media data, and other electronic data already accessible to the device to identify user preference data. The option 840 may be selected to set or enable the device to autonomously augment prompts without an additional user command beyond the initial prompt itself. Thus, an initial prompt might be augmented according to FIG. 4 without the user having to select the selector 430, for example.

Moving on from FIG. 8, also note consistent with present principles that while generative images and generative text have been mentioned above, present principles may also apply to other types of generative outputs, including generative audio. Thus, a user’s initial prompt to a generative audio model might also be augmented with user preference data consistent with present principles.

It may now be appreciated that present principles provide for an improved computer-based user interface that increases the functionality and ease of use of the devices disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a processor system; and
storage accessible to the processor system and comprising instructions executable by the processor system to:
receive a prompt to a generative image model;
augment the prompt with data related to one or more user preferences indicated via user input;
provide the augmented prompt as input to the generative image model; and
based on providing the augmented prompt as input to the generative image model, receive an output from the generative image model, the output indicating a generative image in conformance with the augmented prompt.

2. The device of claim 1, wherein the instructions are executable to:
augment the prompt by using the data to alter the prompt to indicate the one or more user preferences.

3. The device of claim 1, wherein the instructions are executable to:
augment the prompt by appending the data to the prompt as an addition to the prompt.

4. The device of claim 1, wherein the instructions are executable to:
identify the one or more user preferences based on audible, verbal input from a user as received prior to receipt of the prompt.

5. The device of claim 4, wherein the audible, verbal input relates to an object in a geographic area.

6. The device of claim 5, wherein the instructions are executable to identify the one or more user preferences by:
accessing each of: a feature map of the geographic area, a structure mesh of the geographic area, texture data for the geographic area, and a semantic model of the geographic area to identify the object; and
correlating the audible, verbal input related to the object to the one or more user preferences based on the feature map, the structure mesh, the texture data, and the semantic model.

7. The device of claim 6, wherein the generative image model is a first model, and wherein the instructions are executable to:
train a second model, based on the one or more user preferences, to output the data related to the one or more user preferences.

8. The device of claim 7, wherein the second model is different from the first model.

9. The device of claim 8, wherein the second model comprises a large language model.

10. The device of claim 1, wherein the instructions are executable to:
identify the one or more user preferences based on a user’s Internet browser history.

11. The device of claim 1, wherein the instructions are executable to:
identify the one or more user preferences based on a user’s social media data.

12. A method, comprising:
receiving a prompt to a generative image model;
augmenting the prompt with data related to one or more user preferences indicated via user input; and
using the generative image model to, based on the augmented prompt, receive an output indicating a generative image in conformance with the augmented prompt.

13. The method of claim 12, comprising:
providing the augmented prompt as input to the generative image model to use the generative image model to receive the output.

14. The method of claim 12, comprising:
training the generative image model to augment received prompts with user preferences to produce generative outputs that incorporate the one or more user preferences.

15. The method of claim 12, comprising:
identifying the one or more user preferences based on user input as received prior to receipt of the prompt.

16. The method of claim 15, wherein the user input relates to an aspect of a geographic area.

17. The method claim 16, comprising identifying the one or more user preferences by:
accessing texture data for the geographic area and a semantic model of the geographic area; and
correlating the user input to the one or more user preferences based on the texture data and the semantic model.

18. At least one computer readable storage medium (CRSM) that is not a transitory signal, the at least one CRSM comprising instructions executable by a processor system to:
receive a prompt to a model;
augment the prompt with data related to one or more user preferences indicated via user input; and
use the model to, based on the augmented prompt, receive a generative output in conformance with the augmented prompt.

19. The at least one CRSM of claim 18, wherein the model comprises a generative image model, and wherein the output comprises a generative image.

20. The at least one CRSM of claim 18, wherein the model comprises a large language model, and wherein the output comprises generative text.
